(19) United States
(12) Patent Application Publication
(10) Pub. No.: US 2026/0106974 A1
(43) Pub. Date: Apr. 16, 2026

(54) VIDEO DECODING APPARATUS AND VIDEO CODING APPARATUS

(71) Applicant: SHARP KABUSHIKI KAISHA, Sakai City, Osaka (JP)

(72) Inventors: Zheming FAN, Sakai City, Osaka (JP); YUKINOBU YASUGI, Sakai City, Osaka (JP); TOMOHIRO IKAI, Sakai City, Osaka (JP); TOMOKO AONO, Sakai City, Osaka (JP)

(21) Appl. No.: 19/163,502

(22) PCT Filed: Nov. 17, 2023
(86) PCT No.: PCT/JP2023/041439

§ 371 Date: Sep. 9, 2025

(30) Foreign Application Priority Data
Apr. 13, 2023 (JP) 2023-065797
Jun. 30, 2023 (JP) 2023-107954

(51) Int. Cl. H04N 19/11; H04N 19/167; H04N 19/176; H04N 19/196; H04N 19/593

(52) U.S. Cl. CPC H04N 19/11; H04N 19/167; H04N 19/176; H04N 19/196; H04N 19/593

(57) ABSTRACT

To improve the prediction accuracy of the SGPM method, the candidate list of the SGPM method can be expanded. The number and content of the expansion can be selected according to the size and shape of the target block. Also to reduce the complexity of the SGPM, DIMD and TIMD methods. This is achieved by reducing the dependency between SGPM, DIMD and TIMD methods and reducing the number of candidate modes in TIMD.

### TECHNICAL FIELD

The embodiments of the present invention relate to a prediction image generation apparatus, a video decoding apparatus, a video coding apparatus, and a prediction image generation method.

### BACKGROUND ART

A video coding apparatus which generates coded data by coding a video, and a video decoding apparatus which generates decoded images by decoding the coded data are used for efficient transmission or recording of videos.

For example, specific video coding schemes include H.264/AVC, High-Efficiency Video Coding (HEVC), and Versatile Video Coding (VVC) schemes, and the like.

In such a video coding scheme, images (pictures) constituting a video are managed in a hierarchical structure including slices obtained by splitting an image, coding tree units (CTUs) obtained by splitting a slice, units of coding (coding units; which is referred to as CUs) obtained by splitting a coding tree unit, and transform units (TUs) obtained by splitting a coding unit, and are coded/decoded for each CU.

In such a video coding scheme, usually, a prediction image is generated based on a local decoded image that is obtained by coding/decoding an input image (a source image), and prediction error components (which may be referred to also as “difference images” or “residual images”) obtained by subtracting the prediction image from the input image are coded. Generation methods of prediction images include an inter-picture prediction (an inter-prediction) and an intra-picture prediction (intra prediction).

In recent video coding and decoding technique, a Spatial Geometric Partitioning Mode (SGPM) prediction method is proposed by NPL1, in which the decoder derives the prediction image by deriving two intra angular prediction modes and one partition mode using SAD cost which is obtained from candidate list. NPL2 discloses Decoder-side Intra Mode Derivation (DIMD) prediction in which the decoder derives the prediction image by deriving the intra angular prediction mode using pixels in adjacent regions for luma prediction. NPL3 discloses a template matching based intra prediction mode derivation (TIMD) as another decode side intra prediction method. NPL4 discloses Template-based Intra Mode Derivation (TIMD) method, utilizing the most probable modes (MPMs). The SATD (sum of absolute transformed differences) is computed between the prediction and reconstruction samples of a template for each intra prediction mode in MPMs. The TIMD mode and the second TIMD mode are determined as the first and second minimum SATD, respectively. The fusion of these two modes is then employed for intra prediction of the current block.

### CITATION LIST

### Non Patent Literature

NPL 1: Fan Wang (OPPO), Ashwin Natesan (Ittiam), Taoran Lu (Dolby), K. Naser (InterDigital), etc, “EE2-1.6: Combination of spatial GPM tests,” JVET-AB0155, Mainz, DE, October 2022.
NPL 2: M. Abdoli, T. Guionnet, E. Mora, M. Raulet, S. Blasi, A. Seixas Dias, G. Kulupana, “Non-CE3: Decoder-side Intra Mode Derivation with Prediction Fusion Using Planar,” JVET-00449, Gothenburg, July 2019.
NPL 3: K. Cao, N. Hu, V. Seregin, M. Karczewicz, Y. Wang, K. Zhang, L. Zhang, “EE2-related: Fusion for template-based intra mode derivation,” JVET-W0123, Tele-conference, July 2021.
NPL 4: C. Fang, S. Peng, D. Jiang, J.-C. Lin, X. Zhang, H. Jin, X.-M. Shi, F. Ye, “Non-EE2: SGPM combined with multiple IntraTMP predictors”, JVET-AD0148, Antalya, TR, April 2023.

### SUMMARY OF INVENTION

### Technical Problem

The SGPM method extends GPM to intra prediction. SGPM consists of one partition mode and two associated intra prediction modes. Directly signaling these modes in the bit-stream would result in significant overhead bits. To express the necessary partition and prediction information more efficiently in the bit-stream, a candidate list (sgpmMPMList) is employed, and only a candidate index is signaled in the bit-stream. Each candidate in the list can derive a combination of one partition mode and two intra prediction modes.

The SGPM method requires calculating the SAD cost for the candidates in sgpmMPMList and selecting the best intra prediction mode by comparing their SAD costs. The sgpmMPMList is dynamically generated based on the current block's information, so its content varies depending on the target block. In some cases, this list may not include widely used prediction modes (such as Planar, DC, etc.).

NPL1, NPL2, NPL3 and NPL4 discloses decoder side intra derivations which shows high coding performance. However each of them has high complexity for candidate derivation or cost derivation. This invention provides an architecture which provides better balance of complexity and performance.

### Solution to Problem

This invention aims to improve the prediction accuracy of SGPM. Specifically, it expands the candidate list of SGPM to increase the search range and thus improve the accuracy. In this invention, several commonly used intra prediction modes are defined, and after generating the sgpmMPMList, its content is checked. If it does not include the predefined prediction modes, these modes are appended to the sgpmMPMList. This expands the search range of the SGPM method and improves its accuracy.

This invention aims to improve the SGPM and TIMD methods, reducing their execution time to accelerate ECM software. In this invention, the dependency between SGPM and TIMD is eliminated, and the results of the DIMD method are used in the SGPM method as a substitute for the results obtained from the TIMD method for prediction. Additionally, the length of the MPM list used in the TIMD method is shortened based on the frequency of selection of candidate modes in MPM. These enhancements contribute to reducing execution time and improving the efficiency of ECM software.

### Advantageous Effects of Invention

According to an aspect of the present invention, the quality of the codecs can be improved without adding additional calculations.

### BRIEF DESCRIPTION OF DRAWINGS

FIG. 1 is a schematic diagram illustrating a configuration of an image transmission system according to the present embodiment.

FIG. 2 is a diagram showing the hierarchical structure of the coded stream data.

FIG. 3 is a schematic diagram showing the type of intra-prediction mode (mode number).

FIG. 4 is a schematic diagram of the video decoding apparatus.

FIG. 5 shows the structure of the intra prediction image generation unit.

FIG. 6 is a diagram showing the details of the SGPM prediction unit.

FIG. 7 shows the details of the template reference region and template region.

FIG. 8 shows the structure of candidate list used in SGPM prediction unit.

FIG. 9 is a block diagram showing the structure of a video coding apparatus.

FIG. 10 is a diagram showing the details of the TIMD prediction unit.

FIG. 11 shows the structure of the intra prediction image generation unit.

FIG. 12 shows details of the template reference region and template region.

FIG. 13 shows examples of the reference region used for gradient derivation.

FIG. 14 is a diagram showing the details of the DIMD prediction unit.

### DESCRIPTION OF EMBODIMENTS

### First Embodiment

Hereinafter, embodiments of the present disclosure is described with reference to the drawings.

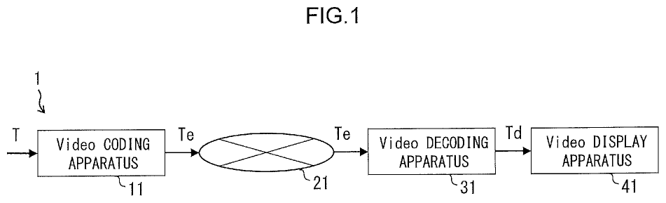

FIG. 1 is a schematic diagram illustrating a configuration of an image transmission system 1 according to the present embodiment.

The image transmission system 1 is a system in which a coding stream obtained by coding a coding target image is transmitted, the transmitted coding stream is decoded, and an image is displayed. The image transmission system 1 includes a video coding apparatus (image coding apparatus) 11, a network 21, a video decoding apparatus (image decoding apparatus) 31, and a video display apparatus (image display apparatus) 41.

An image T is input to the video coding apparatus 11.

The network 21 transmits a coding stream Te generated by the video coding apparatus 11 to the video decoding apparatus 31. The network 21 is the Internet, a Wide Area Network (WAN), a Local Area Network (LAN), or a combination thereof. The network 21 is not necessarily limited to a bidirectional communication network, and may be a unidirectional communication network configured to transmit broadcast waves of digital terrestrial television broadcasting, satellite broadcasting or the like. Furthermore, the network 21 may be substituted by a storage medium in which the coding stream Te is recorded, such as a Digital Versatile Disc (DVD: trademark) or a Blu-ray Disc (BD: trademark).

The video decoding apparatus 31 decodes each of the coding streams Te transmitted from the network 21 and generates one or multiple decoded images Td which are decoded.

The video display apparatus 41 displays all or part of the one or multiple decoded images Td generated by the video decoding apparatus 31. For example, the video display apparatus 41 includes a display device such as a liquid crystal display and an organic Electro-Luminescence (EL) display. Forms of the display include a stationary type, a mobile type, an HMD type, and the like. In addition, in a case that the video decoding apparatus 31 has a high processing capability, an image having high image quality is displayed, and in a case that the apparatus only has a lower processing capability, an image which does not require high processing capability and display capability is displayed.

### Operator

Operators and notations used in the present specification is described below.

>> is an arithmetic right bit shift, <<is an arithmetic left bit shift, & is a bitwise AND, I is a bitwise OR, \hat{ } is a bitwise XOR, |=is an OR assignment operator, and ∥ indicates a logical sum.

x?y:z is a ternary operator to take y in a case that x is true (other than 0) and take z in a case that x is false (0).

Clip3 (x, y, z) is a function to clip z in a value equal to or greater than x and less than or equal to y, and a function to return x in a case that z is less than x (2<x), return y in a case that z is greater than y (z>y), and return z in other cases.

abs (a) is a function that returns the absolute value of a.

Int (a) is a function that returns the integer value of a.

floor (a) is a function that returns the maximum integer equal to or less than a.

ceil (a) is a function that returns the minimum integer equal to or greater than a.

a/d represents division of a by d (round down decimal places).

x=y . . . z represents x takes on integer values starting from y to z, inclusive, with x, y, and z being integer numbers and z being greater than or equal to y.

### Structure of Coding Stream Te

Prior to the detailed description of the video coding apparatus 11 and the video decoding apparatus 31 according to the present embodiment, a data structure of the coding stream Te generated by the video coding apparatus 11 and decoded by the video decoding apparatus 31 is described.

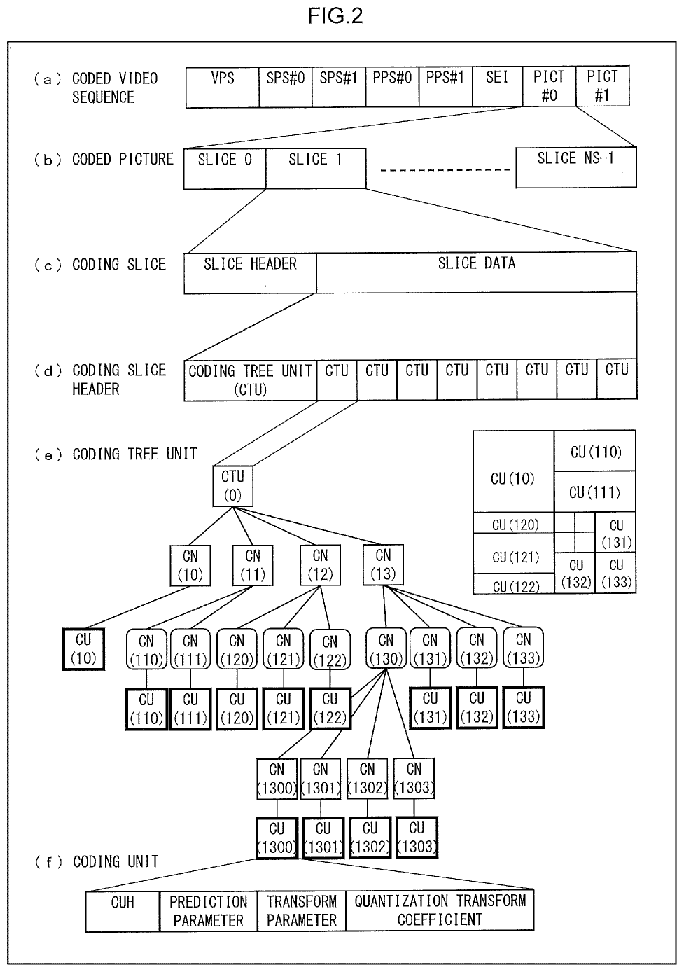

FIG. 2 is a diagram illustrating a hierarchical structure of data of the coding stream Te. The coding stream Te includes a sequence and multiple pictures constituting the sequence illustratively. (a) to (f) of FIG. 2 are diagrams illustrating a coded video sequence defining a sequence SEQ, a coded picture prescribing a picture PICT, a coding slice prescribing a slice S, a coding slice data prescribing slice data, a coding tree unit included in the coding slice data, and a coding unit (CU) included in each coding tree unit, respectively.

### Coded Video Sequence

In the coded video sequence (CVS, coding stream), a set of data referred to by the video decoding apparatus 31 to decode the coded sequence sequences to be processed is defined. As illustrated in FIG. 2, the CVS includes a Video Parameter Set (VPS), a Sequence Parameter Set (SPS), a Picture Parameter Set (PPS), a picture (PICT), and Supplemental Enhancement Information (SEI).

In the video parameter set VPS, in a video including multiple layers, a set of coding parameters common to multiple videos and a set of coding parameters associated with the multiple layers and an individual layer included in the video are defined.

In the sequence parameter set SPS, a set of coding parameters referred to by the video decoding apparatus 31 to decode a target sequence is defined. For example, a width and a height of a picture are defined. Note that multiple SPSs may exist. In that case, any of multiple SPSs is selected from the PPS.

In the picture parameter set PPS, a set of coding parameters referred to by the video decoding apparatus 31 to decode each picture in a target sequence is defined. For example, a reference value (pic_init_qp_minus26) of a quantization step size used for decoding of a picture and a flag (weighted_pred_flag) indicating an application of a weighted prediction are included. Note that multiple PPSs may exist. In that case, any of multiple PPSs is selected from each picture in a target sequence.

### Coded Picture

In the coded picture, a set of data referred to by the video decoding apparatus 31 to decode the picture PICT to be processed is defined. As illustrated in FIG. 2, the picture PICT includes a slice 0 to a slice NS-1 (NS is the total number of slices included in the picture PICT).

Note that in a case that it is not necessary to distinguish each of the slice 0 to the slice NS-1 below, subscripts of reference signs may be omitted. In addition, the same applies to other data with subscripts included in the coding stream Te which is described below.

### Coding Slice

In the coding slice, a set of data referred to by the video decoding apparatus 31 to decode the slice S to be processed is defined. As illustrated in FIG. 2, the slice includes a slice header and a slice data.

The slice header includes a coding parameter group referred to by the video decoding apparatus 31 to determine a decoding method for a target slice. Slice type specification information (slice_type) indicating a slice type is one example of a coding parameter included in the slice header.

Examples of slice types that may be specified by the slice type specification information include (1) I slice using only an intra prediction in coding, (2) P slice using a unidirectional prediction or an intra prediction in coding, and (3) B slice using a unidirectional prediction, a bidirectional prediction, or an intra prediction in coding, and the like. Note that the inter prediction is not limited to a uni-prediction and a bi-prediction, and the prediction image may be generated by using a larger number of reference pictures. Hereinafter, in a case that a slice is referred to as the Por B slice, the slice indicates a slice that includes a block in which the inter prediction may be used.

Note that, the slice header may include a reference to the picture parameter set PPS (pic_parameter_set_id).

### Coding Slice Data

In the coding slice data, a set of data referred to by the video decoding apparatus 31 to decode the slice data to be processed is defined. The slice data include CTUs as illustrated in FIG. 2. The CTU is a block of a fixed size (for example, 64×64) constituting a slice.

### Coding Tree Unit

In FIG. 2, a set of data referred to by the video decoding apparatus 31 to decode the CTU to be processed is defined. The CTU is split into coding units CUs, each of which is a basic unit of coding processing, by a recursive Quad Tree split (QT split), Binary Tree split (BT split), or Ternary Tree split (TT split). The BT split and the TT split are collectively referred to as a Multi Tree split (MT split). Nodes of a tree structure obtained by recursive quad tree splits are referred to as Coding Nodes. Intermediate nodes of a quad tree, a binary tree, and a ternary tree are coding nodes, and the CTU itself is also defined as the highest coding node.

### Coding Unit

As illustrated in FIG. 2, a set of data referred to by the video decoding apparatus 31 to decode the coding unit to be processed is defined. Specifically, the CU includes a CU header CUH, a prediction parameter, a transform parameter, a quantization transform coefficient, and the like. In the CU header, a prediction mode and the like are defined.

There are cases that the prediction processing is performed in units of CU or performed in units of sub-CU obtained by further splitting the CU. In a case that the sizes of the CU and the sub-CU are equal to each other, the number of sub-CUs in the CU is one. In a case that the CU is larger in size than the sub-CU, the CU is split into sub-CUs. For example, in a case that the CU has a size of 8×8, and the sub-CU has a size of 4×4, the CU is split into four sub-CUs which include two horizontal splits and two vertical splits.

There are two types of predictions (prediction modes), which are an intra prediction and an inter prediction. The intra prediction refers to a prediction in an identical picture, and the inter prediction refers to prediction processing performed between different pictures (for example, between pictures of different display times).

Transform and quantization processing is performed in units of CU, but the quantization transform coefficient may be subjected to entropy coding in units of subblock such as 4×4.

### Prediction Parameter

A prediction image is derived by a prediction parameter accompanying a block. The prediction parameter includes prediction parameters of the intra prediction and the inter prediction.

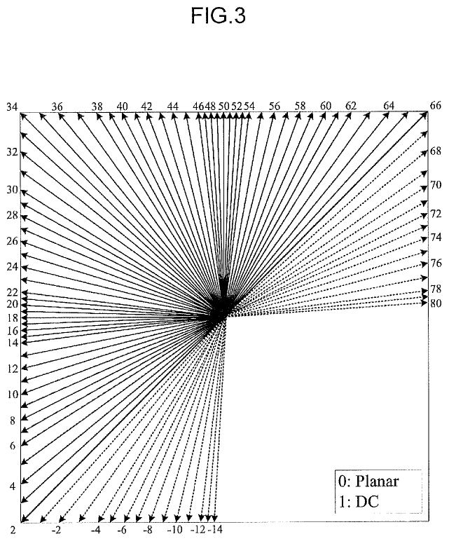

The prediction parameter of the intra prediction is described below. The intra prediction parameter includes a luma intra prediction mode IntraPredMode Y and a chroma intra prediction mode IntraPredModeC. FIG. 3 is a schematic diagram indicating types (mode numbers) of the intra prediction mode. As illustrated in the diagram, for example, there are 67 types (0 to 66) of intra prediction modes. Additionally there are 28 types (−14 to −1 and 67 to 80) of intra prediction modes depend on the aspect ratio of CU. For example, a planar prediction (0), a DC prediction (1), and Angular predictions (2 to 66) are present. Furthermore, for chroma, CCLM (Cross Component Linear Model) prediction mode (81 to 83), MMLM (Multi Mode Linear Model) prediction mode, and LM (Linear Model) prediction mode may be added.

### Configuration of Video Decoding Apparatus

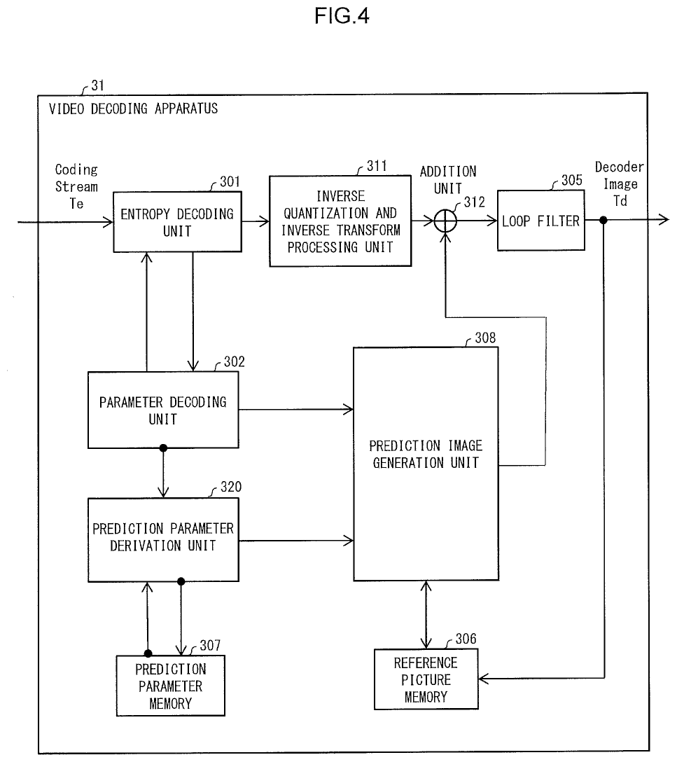

A configuration of the video decoding apparatus 31 (FIG. 4) according to the present embodiment is described.

The video decoding apparatus 31 includes an entropy decoding unit 301, a parameter decoding unit (prediction image decoding apparatus) 302, a loop filter 305, a reference picture memory 306, a prediction parameter memory 307, a prediction image generation unit 308, an inverse quantization and inverse transform processing unit 311, an addition unit 312, and a prediction parameter derivation unit 320. Note that a configuration in which the loop filter 305 is not included in the video decoding apparatus 31 is also used in accordance with the video coding apparatus 11 described later.

The parameter decoding unit 302 further includes a header decoding unit 3020, a CT information decoding unit 3021, and a CU decoding unit 3022 (prediction mode decoding unit), and the CU decoding unit 3022 further includes a TU decoding unit 3024. These may be collectively referred to as a decoding module. The header decoding unit 3020 decodes, from coded data, parameter set information such as the VPS, the SPS, and the PPS, and a slice header (slice information). The CT information decoding unit 3021 decodes a CT from coded data. The CU decoding unit 3022 decodes a CU from coded data. In a case that a TU includes a prediction error, the TU decoding unit 3024 decodes QP update information (quantization correction value) and a quantization prediction error (residual_coding) from coded data.

Furthermore, an example in which a CTU and a CU are used as units of processing is described below, but the processing is not limited to this example, and processing in units of sub-CU may be performed. Alternatively, by replacing the CTU and the CU by a block and replacing the sub-CU by a subblock, and processing in units of blocks or subblocks may be performed.

The entropy decoding unit 301 performs entropy decoding on the coding stream Te input from the outside and separates and decodes individual codes (syntax elements). The separated codes include prediction information to generate a prediction image, a prediction error to generate a difference image, and the like. Entropy coding has a variable length coding method for syntax elements according to the context (probability model) adaptively selected according to the type of syntax elements and the surrounding conditions, and a variable length coding method for syntax elements using a predetermined table or formula.

The parameter decoding unit 302 notifies the entropy decoding unit 301 of which syntax elements need be decoded. The entropy decoding unit 301 outputs the syntax element to the prediction parameter derivation unit 320.

### Configuration of Prediction Parameter Derivation Unit 320

The prediction parameter derivation unit 320 may derive the prediction parameters based on the output of the parameter decoding unit 302 and the prediction parameters which saved in the prediction parameter memory 307. The derived prediction parameters is output into the prediction image generation unit 308 and also is saved in the prediction parameter memory 307. The prediction parameter derivation unit may derive different prediction mode for the Luma and Chroma prediction.

The loop filter 305 is a filter provided in the coding loop, and is a filter that removes block distortion and ringing distortion and improves image quality. The loop filter 305 applies a filter such as a deblocking filter, a Sample Adaptive Offset (SAO), and an Adaptive Loop Filter (ALF) on a decoded image of a CU generated by the addition unit 312.

The reference picture memory 306 stores the decoded image of the CU generated by the addition unit 312 in a predetermined position for each target picture and target CU.

The prediction parameter memory 307 stores prediction parameters in a predetermined position for each CTU or CU to be decoded. Specifically, the prediction parameter memory 307 stores a parameter derived by the prediction parameter derivation unit 320, a prediction mode predMode separated by the entropy decoding unit 301, and the like.

The prediction image generation unit 308 receives input of the prediction parameter derived by the prediction parameter deviation unit 320, and the like. In addition, the prediction image generation unit 308 reads a reference picture from the reference picture memory 306. The prediction image generation unit 308 generates a prediction image of a block or a subblock by using the prediction parameter and the read reference picture (reference picture block) in the prediction mode indicated by the prediction mode predMode. Here, the reference picture block refers to a set of pixels (referred to as a block because they are normally rectangular) on a reference picture and is a region that is referred to generate a prediction image.

### Prediction Image Generation Unit 308

In a case that the prediction mode predMode indicates an intra prediction mode, the intra prediction image generation unit 310 performs an intra prediction by using an intra prediction parameter (luma intra prediction mode IntraPredModeY and/or chroma intra prediction mode IntraPredModeC) input from the prediction parameter derivation unit 320 and reference pixels read from the reference picture memory 306. In a case that the prediction mode predMode indicates an inter prediction mode, the inter prediction image generation unit performs an inter prediction by using an inter prediction parameter input from the prediction parameter derivation unit 320 and reference pixels read from the reference picture memory 306.

Specifically, the prediction image generation unit 308 reads, from the reference picture memory 306, a neighbouring block in a predetermined range from a target block on a target picture. The predetermined range is neighbouring blocks on the left, the top left, the top, and the top right of the target block, and the region referred to is different depending on the intra prediction mode.

The prediction image generation unit 308 generates a prediction image of the target block with reference to the read decoded pixel values and the prediction mode indicated by predMode, IntraPredMode Y and/or IntraPredModeC. The prediction image generation unit 308 outputs the generated prediction image of the block to the addition unit 312.

The generation of the prediction image based on the intra prediction mode is described below. In the Planar prediction, the DC prediction, and the Angular prediction, a decoded peripheral region adjacent to (proximate to) the prediction target block is configured as a reference region R. Then, the pixels on the reference region R are extrapolated in a specific direction to generate the prediction image. For example, the reference region R may be configured as an L-shaped region including the left and top (or further, top left, top right, bottom left) of the prediction target block.

### Intra Prediction Image Generation Unit 310

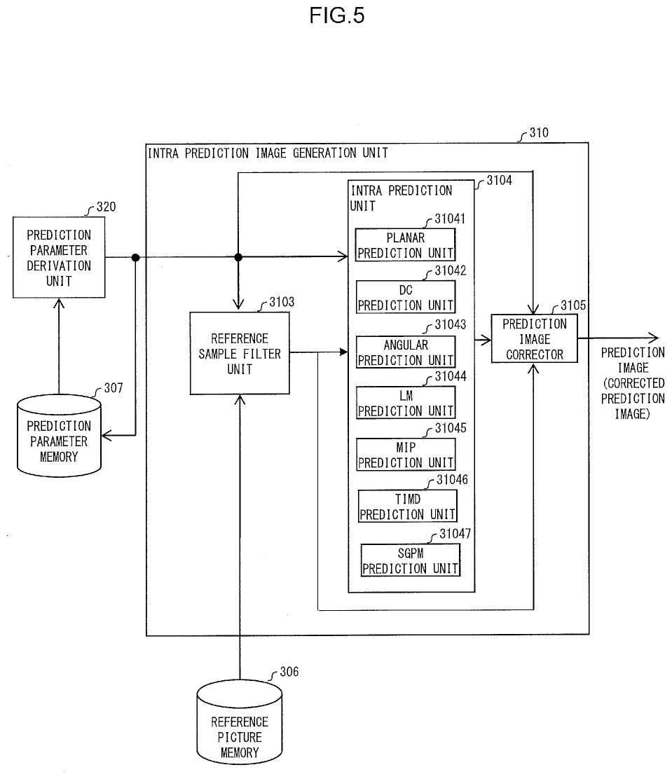

A configuration of the intra prediction image generation unit 310 is described using FIG. 5. The intra prediction image generation unit 310 includes a reference sample filter unit 3103 (second reference image configuration unit), an intra prediction unit 3104), and a prediction image corrector 3105 (prediction image corrector, filter switching unit, weight coefficient changing unit).

Based on each reference pixel (unfiltered reference image) on the reference region R, a filtered reference image generated by applying a reference pixel filter (first filter), and the intra prediction mode, the intra prediction unit 3104 generates a prediction image of the target block, and outputs the generated image to the prediction image corrector 3105. The prediction image corrector 3105 corrects the prediction image in accordance with the intra prediction mode, and outputs a corrected prediction image.

Hereinafter, the units included in the intra prediction image generation unit 310 is described.

### Reference Sample Filter Unit 3103

The reference sample filter unit 3103 applies the reference pixel filter (first filter) to the unfiltered reference image to derive a filtered reference image s [x][y] at each position (x, y) on the reference region R, in accordance with the intra prediction mode. Specifically, a low pass filter is applied to the unfiltered reference image at each position (x, y) and its surroundings, and a filtered reference image is derived. Note that the low pass filter need not necessarily be applied in all the intra prediction modes, and the low pass filter may be applied in some intra prediction modes. Note that the filter applied to an unfiltered reference image on a reference region R in the reference sample filter unit 3103 is referred to as the “reference pixel filter (first filter)”, whereas a filter that corrects the prediction image in the prediction image corrector 3105 described below is referred to as a “boundary filter (second filter)”.

### Configuration of Intra Prediction Unit 3104

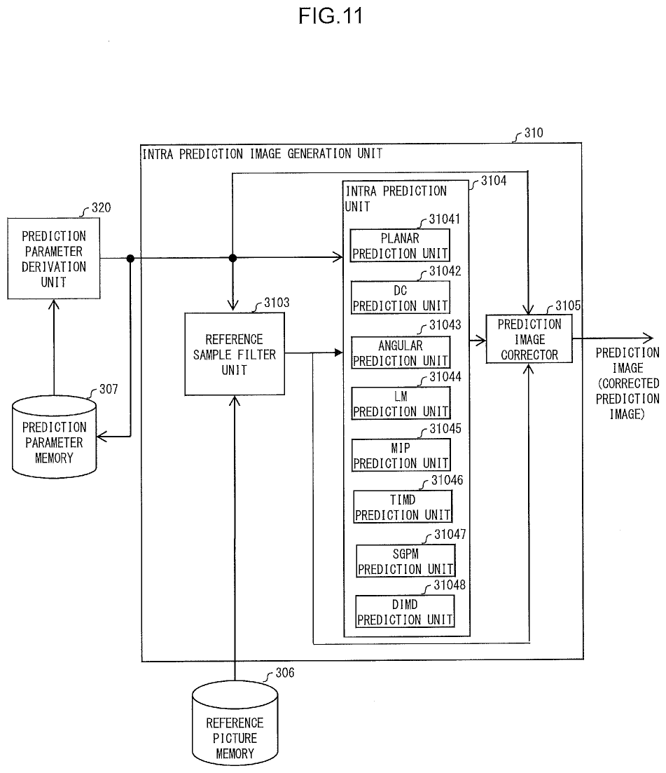

The intra prediction unit 3104 generates, based on the intra prediction mode, the unfiltered reference image, and the filtered reference pixel value, a prediction image (prediction pixel value, uncorrected prediction image) of the prediction target block, and outputs a generated image to the prediction image corrector 3105. The intra prediction unit 3104 includes a Planar prediction unit 31041, a DC prediction unit 31042, an Angular prediction unit 31043, an LM prediction unit 31044, an MIP prediction unit (Matrix-based Intra Prediction) 31045, a TIMD (Template based Intra Mode Derivation) prediction unit 31046, and a SGPM prediction unit 31047 in the inside thereof. Also the intra prediction unit 3104 may include a DIMD (Decoder side Intra Mode Derivation) prediction unit 31048, shown in FIG. 11. The intra prediction unit 3104 selects a specific predictor in accordance with the intra prediction mode, and inputs an unfiltered reference image and a filtered reference image thereto. The relationship between the intra prediction mode and the corresponding predictor is as follows.
Planar prediction . . . Planar prediction unit 31041
DC prediction . . . DC prediction unit 31042
Angular prediction . . . Angular prediction unit 31043
LM prediction . . . LM prediction unit 31044
MIP prediction . . . MIP prediction unit 31045
TIMD prediction . . . TIMD prediction unit 31046
SGPM prediction . . . SGPM prediction unit 31047
DIMD prediction . . . prediction unit 31048 (in FIG. 11)

### Planar Prediction

The Planar prediction unit 31041 generates a prediction image q[x][y] by linearly adding multiple filtered reference images s[x][y] in accordance with the distance between the prediction pixel position and the reference pixel position, and outputs the generated image to the prediction image corrector 3105.

### DC Prediction

The DC prediction unit 31042 derives a DC prediction value corresponding to the average value of the filtered reference image s[x][y], and outputs a prediction image q[x][y], which takes the DC prediction value as a pixel value.

### Angular Prediction

The Angular prediction unit 31043 generates a prediction image q[x][y] using the filtered reference image s[x][y] in a prediction direction (reference direction) indicated by the intra prediction mode, and outputs the generated image to the prediction image corrector 3105.

### LM Prediction

The LM prediction unit 31044 predicts the pixel value of the chroma based on the pixel value of luma. More specifically, a linear model is used to generate a prediction chroma image (Cb, Cr) based on the decoded luma image. As an example of LM prediction, there is a CCLM (cross component linear model prediction) prediction. CCLM prediction is a prediction method using a linear model to predict chroma from luma to same block.

### MIP Prediction

The MIP prediction unit 31045 generates a prediction image q[x][y] by the product sum operation on the reference sample s[x][y] and the weight matrix derived from the neighboring region, and outputs the prediction image q[x][y] to the prediction image corrector 3105.

### DIMD Prediction

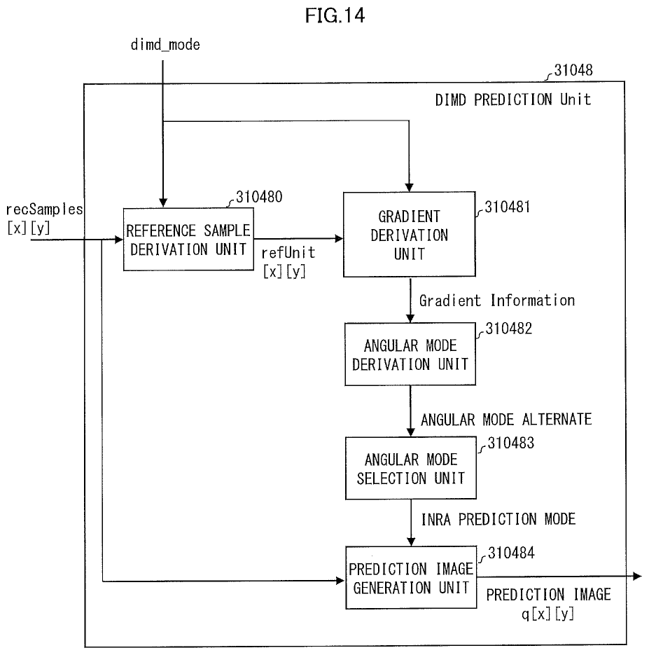

The DIMD prediction unit 31048, shown in FIG. 14, comprises a reference sample derivation unit 310480, a gradient derivation unit 310481, angular mode derivation unit 310482, an angular mode selection unit 310483 and a prediction image generation unit 310484. For each target block, the prediction parameter derivation unit 320 decodes a flag named dimd_flag used for indicating if this target block uses DIMD method.

When dimd_flag is 1, the DIMD prediction unit 31048 derives an angular mode indicating the texture direction in the neighboring region by pixel value. This angular mode will be used to generate an intra prediction image. The reference sample derivation unit 310480 derives reference samples from neighbouring samples of the target block. It may be a set of reference mode, indicated by dimd_mode.
dimd_mode=0 DIMD_MODE_TOP_LEFT (using top neighbouring reference region and left neighbouring reference region)
dimd_mode=1 DIMD_MODE_LEFT (using left neighbouring reference region)
dimd_mode=2 DIMD_MODE_TOP (using top neighbouring reference region)

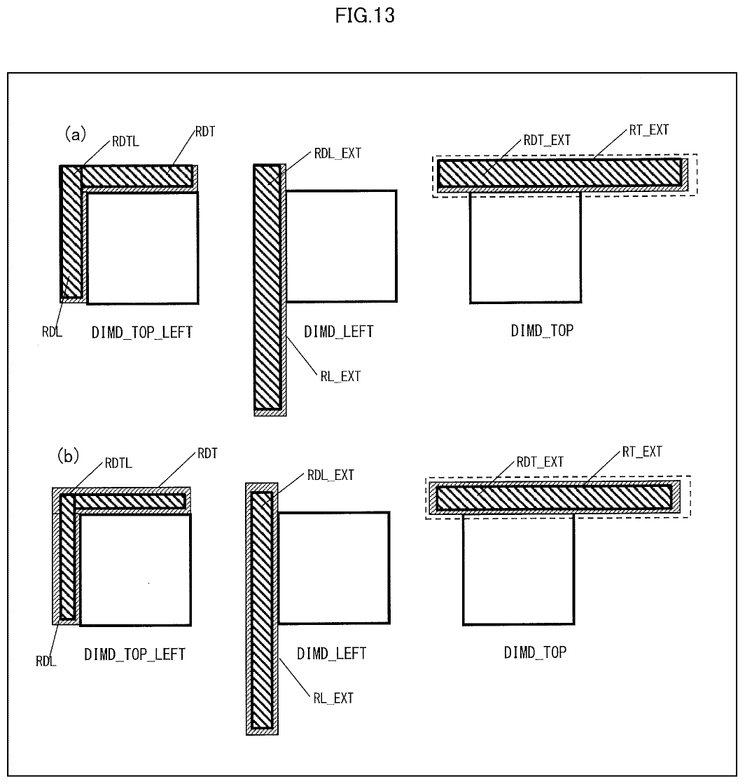

FIG. 13(b) shows an example of the reference range used in the processing of gradient derivation of the dimd prediction. In this case, the 3×3 filter (filterIdx==1) is used.

When dimd_mode==DIMD_MODE_TOP_LEFT, the angular mode derivation unit 310462 derives Dx and Dy from the each point P of the left region RDL of the target block, derives mode Val and conducts histogram counting operation. Subsequently, Dx and Dy are derived from each point P of the above region RDT of the target block, and mode Val is derived and histogram counting is conducted.

The area of RDL is x=−refIdxW . . . −2, y=−refIdxH . . . refH−2.

The area of RDT is x=−refIdx W . . . refW−2, y=−refIdxH . . . −2 refIdxW and refIdxH is a constant indicating the width and height of the reference region on the target block. RDTL is an area in which RDL and RDT are combined. When dimd_mode==DIMD_MODE_LEFT, the angular mode derivation unit 310482 use the extension left region RDL_EXT of the target block, for example, Dx and Dy from the RDL_EXT, for deriving and counting mode Val.

The area of RDL_EXT is x=−refIdxW . . . −2, y=−refledxH . . . refH*2−2.

When dimd_mode==DIMD_MODE_TOP, the angular mode derivation unit 310482 derives mode Val from the extension above region RDT_EXT of the target block, and conducts histogram counting.

The area of RDT_EXT is x=−refIdxW . . . refW*2−2, y=−refIdxH . . . −2

Here, refIdxW=2, refledxH=2, refH=bH (the height of target block), refW=bW (the width of target block).

Similarly, for the cases using 2×2 filter, the reference region for gradient deriving is shown in FIG. 13(a).

In the cases using 2×2 filter:

The area of RDL is x=−refIdxW . . . −2, y=−refledxH . . . refH−2

The area of RDT is x=−refIdx W . . . refW−2, y=−refIdxH . . . −2

RDTL is an area in which RDL and RDT are combined.

The area of RDL_EXT is x=−refIdxW . . . −2, y=−refledxH . . . refH*2−2

The area of RDT_EXT is x=−refIdxW . . . refW*2−2, y=−refIdxH . . . −2

Here, refIdxW=2, refIdxH=2, refH=bH (the height of target block), refW=bW (the width of target block).

The gradient derivation unit 310481 derives pixel gradient Dx and Dy using the pixel values P[x][y] for a given position (x, y) in the reference samples.

The following formula may used for gradient derivation.

$$Dx = P [ x ] [ y ] + P [ x ] [ y + 1 ] - P [ x + 1 ] [ y ] - P [ x + 1 ] [ y + 1 ]$$

$$Dy = P [ x ] [ y ] + P [ x + 1 ] [ y ] - P [ x ] [ y + 1 ] - P [ x + 1 ] [ y + 1 ]$$

Alternatively the following formula may used for gradient derivation.

$$Dx = P [ x - 1 ] [ y + 1 ] + 2 * P [ x ] [ y + 1 ] + P [ x + 1 ] [ y + 1 ] - P [ x - 1 ] [ y - 1 ] - 2 * P [ x ] [ y - 1 ] - P [ x + 1 ] [ y - 1 ]$$

$$Dy = P [ x - 1 ] [ y - 1 ] + 2 * P [ x - 1 ] [ y ] + P [ x - 1 ] [ y + 1 ] - P [ x + 1 ] [ y - 1 ] - 2 * P [ x + 1 ] [ y ] - P [ x + 1 ] [ y + 1 ]$$

The gradient derivation unit 310481 derives signx, signy, xgty and quadrant as follows.

$$absx = abs ( Dx )$$

$$absy = abs ( Dy )$$

$$signx = Dx < 0 ? 1 : 0$$

$$signy = Dy < 0 ? 1 : 0$$

$$xgty = absx > absy ? 1 : 0$$

$$quadrant = xgty ? ( ( signx \hat{} signy ) ? 1 : 0 ) : ( ( signx \hat{} signy ) ? 2 : 3 )$$

Here, unequal sign (>, <) can be replaced by (>=, <=). The angular information can be derived from the signx, signy, and xgty. \hat{ } is an XOR calculation. The quadrant is represented by the value from 0 to 3, {Ra, Rb, Rc, Rd}={0, 1, 2, 3}. The value of the quadrant is not limited to the above.

The angular mode derivation unit 310482 derives iRatio.

$$iRatio = R\_UNIT * absy / absx$$

R_UNIT is the exponential power of 2 (1<<shiftR), e.g. R_UNIT=65536 when shiftR=16. The division may be replaced with “multiplied by its reciprocal”. The reciprocal is derived by a LUT.
e.g. LUT [k]=R_UNIT/k, iRatio=absy*LUT [absx]

The angular mode derivation unit 310482 converts the derived pixel gradient to an angular prediction mode, mode Val by searching corresponding angular mode corresponding to the iRatio.

```
  mode_delta = 16;
  for( int i = 1; i < 17; i++ ){
  if( iRatio <= angTable[i] ){
  mode_delta = iRatio − angTable[i − 1] < angTable[i] − iRatio ? i − 1 : i;
  break;
  }
  }
  modeVal = base_mode[quadrant] + direction[quadrant] * mode_delta
  angTable = { 0, 2048, 4096, 6144, 8192, 12288, 16384, 20480, 24576, 28672,
32768, 36864, 40960, 47104, 53248, 59392, 65536 }.
  base_mode[4] = {18, 18, 50, 50}
  direction[4] = {−1, 1, −1, 1}
```

The angular mode derivation unit 310482 counts the number of mode Val derived from the reference region. It may build a histogram, HistMode[ ] using derived angular prediction mode.

$$HistMode [ modeVal ] += 1$$

An angular mode selection unit 310483 selects an intra prediction mode with the highest number of occurrence (highest count), dimdMode, from the histogram. In the following, the selected intra prediction are called dimdBestMode (if DIMD_MODE_TOP_LEFT is used), dimdHorMode (if DIMD_MODE_LEFT is used), and dimdVerMode (if DIMD_MODE_VER is used). An angular mode selection unit 310483 may select the second mode with the second highest number as dimdSecondaryMode. Then a prediction image generation unit 310484 may generate a DIMD prediction image using the derived dimdBestMode. DIMD prediction image may be a weighted average of prediction image using dimdBestMode and a prediction image using dimdSecondaryMode.

### TIMD Prediction

The TIMD prediction unit 31046 derives an intra prediction mode (a template-based intra prediction mode, TIMD intra prediction mode) by template matching and generate a prediction image using the derived intra prediction mode. The TIMD prediction unit 31046 first generates a template image located in the adjacent region (template region). Then, using the image in the reference region (template reference region), the TIMD prediction unit 31046 generates template prediction images for multiple intra prediction mode candidates. Finally, the TIMD prediction unit 31046 selects one or more candidate (TIMD intra prediction modes, timdBestMode, timdSecoundaryMode) with the minimum cost between the template image and the template prediction image. The TIMD prediction unit 31046 generates the intra prediction image using the derived TIMD intra prediction modes. TIMD prediction unit 31046 may select timdHorMode using left neighbouring region of the target block and select timdVerMode using top neighbouring region of the target block. timdBestMode, timdSecoundaryMode, timdHorMode, timdVerMode may be referred as timdMode.

### SGPM Prediction

The SGPM (Spatial Geometric Partitioning Mode) is a prediction method in which a prediction image of SGPM is generated as a combined image of two intra prediction images based on geometric partitioning weights. A flag sgpm_flag is encoded and decoded in a bitstream to indicate whether a target block uses the SGPM method. The parameter of SGPM prediction consists of a partition mode for the weighting and two associated intra prediction modes. When sgpm_flag is 1, the SGPM prediction unit 31047 derives two angular modes and a partition mode which is used to generate an intra prediction image. The combination of the two intra prediction images is conducted by adding weighted intra prediction images. The intra prediction image is generated based on the two associated intra prediction modes and the weighting value (geometric partitioning weight) is generated based on the partition mode. The prediction SGPM unit 31047 may use the intra prediction modes derived by the TIMD prediction unit 31046. For the target block, it derives a partition mode to divide the target block into two parts, each of which uses the corresponding intra prediction mode. A weight image is generated depending on the partition mode. Finally, using the weight image, the two intra prediction images are combined to derive the intra prediction image. Details is described later.

### Configuration of Prediction Image Corrector 3105

The prediction image corrector 3105 corrects the prediction image output from the intra prediction unit 3104 in accordance with the intra prediction mode. Specifically, the prediction image corrector 3105 derives, by performing weighted addition (weighted-averaging) on the unfiltered reference image and the prediction image for each pixel of the prediction image, in accordance with the distance between the reference region R and the target prediction pixel, the prediction image (corrected prediction image) Pred in which the prediction image is modified. Note that in some intra prediction modes (for example, Planar prediction, DC prediction, or the like), the prediction image corrector 3105 may not correct the prediction image, and the output of the intra prediction unit 3104 may be used as the prediction image.

### APPLICATION EXAMPLES

### SGPM Prediction Unit 31047

When sgpm_flag is equal to 1, the current block is predicted using the SGPM method. In this case, SGPM derives a candidate list with a partition mode and two intra prediction modes from the reconstructed neighboring regions of the current block and select a candidate with sgpm_index, and generate the prediction pixel values for the current block using the selected candidate.

A process of the SGPM method is summarised as follows:
Step 1: Derive a template image and a template reference samples based on the available neighboring regions.
Step 2: Generate a first candidate list (partModeList), where each candidate consists of a partition mode and two intra prediction modes.
Step 3: Generate a second candidate list (IPModeList) consists of intra prediction modes.
Step 4: For each candidate combining the first candidate list and second candidate list, generate template prediction image.
Step 5: Calculate cost between the template prediction image and the template image and select candidates with numSorted minimum costs. Generate a third list (sorted MPM list, sgpmMPMList) which has ascending order of the cost of each candidates. The cost may be SATD. numSorted is a predefined value, the length of the third list. numSorted may be 16 but not limited to 16.
Step 6: Select one candidate as an intra prediction mode for the target block based on the sgpm_index. sgpm_index indicates two intra prediction modes for the target block.

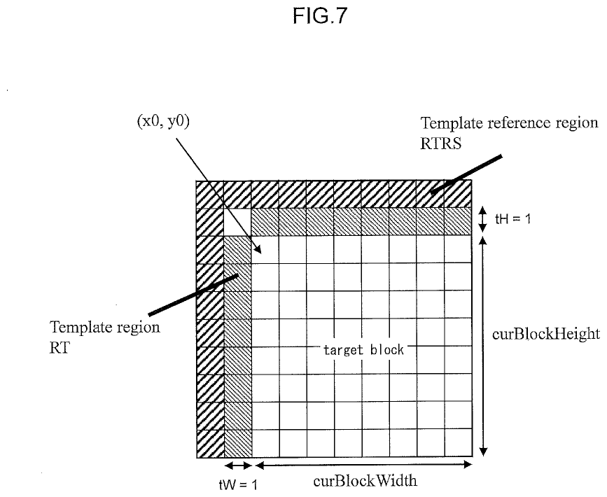

FIG. 7 shows the template region RT and the template reference region (template reference sample region) RTRS used for SGPM prediction. The template region corresponds to the region of the template image. The template reference region RTRS is the region referenced when generating the template prediction image. tW and tH represent the width and height of the template image, respectively. curBlockHeight is the height of current block, curBlockWidth is the width of current block

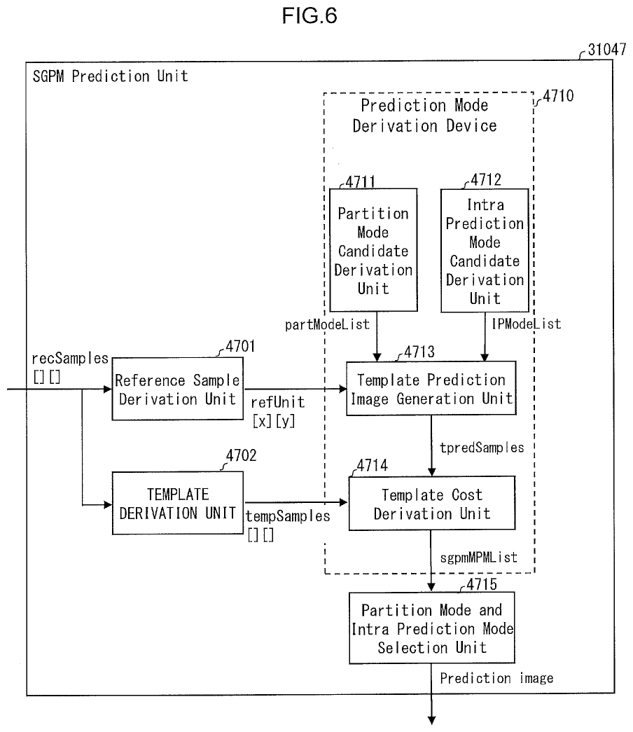

FIG. 6 shows the configuration of the SGPM prediction unit 31047 in this embodiment. The SGPM prediction unit 31047 comprises a reference sample derivation unit 4701, a template derivation unit 4702, a partition mode and intra prediction mode selection unit 4715, and a prediction mode derivation device 4710 which includes a partition mode candidate derivation unit 4711, an intra prediction mode candidate derivation unit 4712, a template prediction image generation unit 4713, and a template cost derivation unit 4714.

### Reference Sample Derivation Unit 4701

The reference sample derivation unit 4701 derives a reference sample refUnit from the previously decoded pixel recSamples adjacent to the target block which is named RTRS. Note that, the reference sample derivation unit 4701 may include in the reference sample filter unit 3103. The reference sample derivation unit 4701 stores recSamples into a reference sample refUnit by following:

$$refUnit [ x ] [ y ] = recSamples [ x 0 + x ] [ y 0 + y ]$$

where x=−tW−1, y=−1−tH . . . curBlockHeight−1, and x=−tW . . . curBlockWidth−1, y=−1−tH. (x0, y0) is a top left coordinate of the template regiontarget block.

### Template Derivation Unit 4702

The template derivation unit 4702 derives a template image tempSamples from template region RT as follows.

$$tempSamples [ i ] [ j ] = recSamples [ x 0 + i ] [ y 0 + j ] ( i = 0 … curBlockWidth - 1 , j = - tH … - 1 , and i = - tW … - 1 , j = 0 … curBlockHeight - 1 )$$

where the template region RT is an L-shaped array of recSamples. The RT is expressed as a set of coordinates (i, j). RT={{i=0 . . . curBlock Width−1, j=−tH . . . 1}, {i=−tW . . . −1, j=0 . . . curBlockHeight−1}}. (tW,tH) may be set equa to (1,1). (tW,tH) may be set equa to (2,2) or other values.

### Partition Mode Candidate Derivation Unit 4711

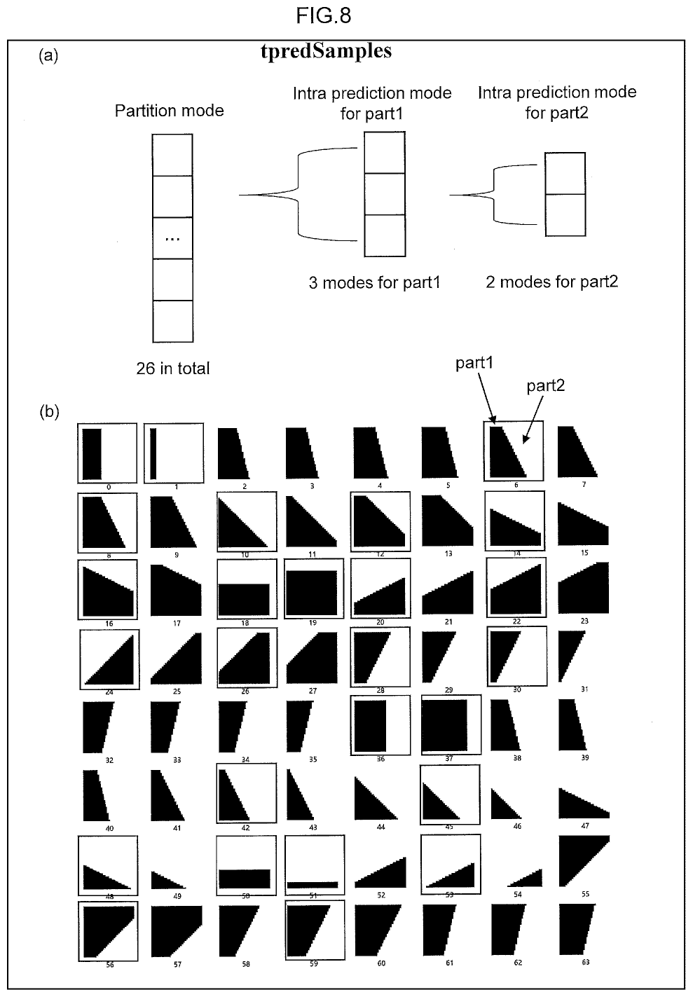

The partition mode candidate derivation unit 4711 derive the list of partition modes, called partModeList, which has a fixed length of numPartMode. numPartMode may set equal to 26. The current block is divided into 2 regions (part1 and part2) shown as FIG. 8(b). partModeList includes, for example, shapes surrounded by a black frame.

### Intra Prediction Mode Candidate Derivation Unit

The intra prediction mode candidate derivation unit 4712 derives a list of intra prediction modes, named IPModeList, based on the current block's information. The length of IPModeList is numIPMode, which may set equal to 1, 2, 3, 4, 5 or other values. Some elements of IPModeList can be set equal to fixed modes, e.g. PLANAR_IDX (planar mode), VER_IDX (vertical direction for angular mode), and HOR_IDX (horizontal direction for angular mode). Other elements can be determined based on the neighbouring pixel's information of the current block. For example, element can include DIMD method's dimdBestMode, dimdSecondMode, and dimdThirdMode, or the TIMD method's timdHorMode, timdVerMode, and timdBestMode. This allows all 67 intra prediction modes to be filled into the list. 67 intra prediction modes are from 0 to 66 shown in FIG. 3. dimdBestMode, dimdSecondMode and dimdThirdMode are modes with the minimum, second minimum and third minimum DIMD cost, respectively. timdHorMode, timdVerMode and timdBestMode are modes with the minimum cost from the left template, the minimum cost from the upper template and the minimum cost from both upper and left template, respectively. For example, the intra prediction mode candidate derivation unit 4712 may select the timdVerMode, timdHorMode and the ipmBestMode. ipmBestMode is a mode with the minimum cost from the 67 intra prediction mode. Furthermore, the element of the list can set equal to the intra prediction mode of the adjacent blocks which may include blocks located to the above-left, bottom-left, left, top, and above-right of the current block.

The intra prediction mode candidate derivation unit 4712 may adjust IPModeList dynamically. Specifically, one or more predefined intra prediction modes, such as Planar mode and DC mode, may be added to IPModeList. The intra prediction mode candidate derivation unit 4712 checks IPModeList to see if it includes the predefined intra prediction modes. If it does not include a predefined intra prediction mode, the modes are added to IPModeList. For example, if IPModeList includes PLANAR_IDX, VER_IDX, and HOR_IDX but not includes DC mode, DC_IDX is added to IPModeList. As a result, the length of IPModeList increases to 4 and its contents are PLANAR_IDX, VER_IDX, HOR_IDX, and DC_IDX.

The intra prediction mode candidate derivation unit 4712 may add candidates to IPModeList based on the current block size. The decision to add IPModeList is based on comparing thresholds with the size of the current block. For example, if the height and width of the current block are greater than the threshold, i.e., curBlockHeight>heightThreshold and curBlockWidth>widthThreshold, the candidate addition is performed. As for widthThreshold and heightThreshold, the horizontal and vertical thresholds may be set to the same value, such as (4,4), (8,8), (16,16), (32,32), (64,64) or different values, such as (4,8), (8,4), (32,8), (16,64), (128,16), etc.

$$if ( ( curBlockHeight < heightThreshold \&\& curBlockWidth < widthThreshold ) \vert \vert ( curBlockHeight > heightThreshold \&\& curBlockWidth > widthThreshold ) ) numIPMode += 1$$

The intra prediction mode candidate derivation unit 4712 may derives IPModeList based on the current block shape. The intra prediction mode candidate derivation unit 4712 may use two ore more candidate lists, IPModeList1, IPModeList2, . . . . When the current block's height and width are smaller than the corresponding thresholds (i.e., curBlockHeight<heightThreshold and curBlockWidth<widthThreshold), IPModeList1 is used for IPModeList. Otherwise (curBlockHeight>=heightThreshold and curBlockWidth>=widthThreshold), IPModeList2 is used for IPModeList.

if (curBlockHeight < heightThreshold && curBlockWidth < widthThreshold)
IPModeList = IPModeList1
else if (curBlockHeight > heightThreshold && curBlockWidth > widthThreshold)
IPModeList = IPModeList2
IPModeLists may be defined as IPModeList1 = {PLANAR_IDX, DC_IDX} and IP-
ModeList2 = {VER_IDX, HOR_IDX}

The intra prediction mode candidate derivation unit 4712 may add candidates to IPModeList based on the current block shape. For example, when the height of the current block is different from its width, i.e., curBlockHeight>curBlockWidth or curBlockHeight<curBlockWidth, The intra prediction mode candidate derivation unit 4712 may add a candidates to IPModeList.

$$if ( curBlockHeight > curBlockWidth \vert \vert curBlockHeight < curBlockWidth ) \text{} numIPMode += 1$$

The intra prediction mode candidate derivation unit 4712 may derives IPModeList based on the current block shape in which different list is selected whether width>height or width<height.

```
  if (curBlockHeight > curBlockWidth)
  IPModeList = IPModeList1
  else if (curBlockHeight < curBlockWidth)
  IPModeList = IPModeList2
  else if (curBlockHeight == curBlockWidth)
  IPModeList = IPModeList3
  IPModeLists may be defined as IPModeList1 = {2, DIA_IDX} and
IPModeList2 = {DIA_IDX, VDIA_IDX}
```

The intra prediction mode candidate derivation unit 4712 may derives IPModeList using extended angle modes or wide angle intra prediction modes. The extended angle modes refer to more refined angle modes based on the intra prediction modes shown in FIG. 3, derived by adding an angular prediction mode between every two angle prediction modes. The following functions MAP67TO131( ) and MAP131TO67( ) may be used to convert mode numbers:

$$MAP 131 TO 67 ( mode ) = ( mode < 2 ? mode : ( ( mode >> 1 ) + 1 ) )$$

$$MAP 67 TO 131 ( mode ) = ( mode < 2 ? mode : ( ( mode << 1 ) - 2 ) )$$

The intra prediction mode candidate derivation unit 4712 may derives IPModeList as the extended angle modes applying MAP67TO131 to predefined or derived intra prediction mode. If the predefined intra prediction modes are {18, 34, 50}, the derived IPModeList is {34, 66, 98} as MAP67TO131(18)=34, MAP67TO131(34)=66 and MAP67TO131(50)=98.

Furthermore, the extended angle modes may be updated by adding variants of the current (already included) IPModeList. The variants can be determined by adding or subtracting one to a mode number in the current IPModeList. For example, in the case that IPModeList include {34, 66, 98}, 34 plus or minus 1, 66 plus or minus 1 and 98 plus or minus 1 may be added. Thus {33, 35, 65, 67, 97, 99} is added to IPModeList as the extended angle modes.

The wide angle intra prediction modes refer to the modes with its mode numbers in the range of [−1, −14] and [67, 80] shown in FIG. 3, which are defined to predict rectangular target blocks. The wide angle intra prediction modes may be added to the IPModeList when the current block shape is large aspect ratio.

### Template Prediction Image Generation Unit 4713

The template prediction image generation unit 4713 generates the template prediction image based on the intra prediction mode (intraPredMode) and partition mode, called the template prediction image (tpredSamples). An example of numPartMode=26 and numIPMode=3 is described below but numPartMode does not have to be 26 and numIPMode does not have to be 3. First, the template prediction image generation unit 4713 creates first template prediction images for each mode in the IPModeList. Next, the template prediction image generation unit 4713 creates second template prediction image by combining first template prediction images based on every partition mode in partModeList. In other words, there are 6 second template prediction images, such as (part1 intra prediction mode, part2 intra prediction mode)={(IPModeList[0], IPModeList[1]), (IPModeList[0], IPModeList[2]), (IPModeList[1], IPModeList[0]), (IPModeList[1], IPModeList[2]), (IPModeList[2], IPModeList[0]), (IPModeList[2], IPModeList[1])} for every partition mode. A shape (partMode) of part1 and shape of part2 are based on partModeList shown as FIG. 8(b). The second template prediction images are stored in a three-dimensional array tpredSamples[26][3][2] shown in FIG. 8 (a). In this case the template prediction image generation unit 4713 derives 156 (26*3*2) template prediction images.

### Template Cost Derivation Unit 4714

The template cost derivation unit 4714 derives the cost of the candidates by using tempSamples generated by the template derivation unit 4702 and tpredSamples generated by the template prediction image generation unit 4713. In this unit, the costs of all candidates are calculated for comparison, and stored in costMode[numPartMode][numIPMode][numPartMode−1]. An example with numPartMode=26 and numIPMode=3 is described below but numPartMode is not limited to 26 and numIPMode does not have to be 3. The cost may be calculated using the sum of absolute transformed differences (SATD). After obtaining costs for each partModeList[i] (e.g. i=0 . . . 25) and each IPMode[j] (e.g. j=0 . . . 2), the template cost derivation unit 4714 selects the numStored minimum cost set for costMode[i][j][k] (i=0 . . . 25, j=0 . . . 2, k=0 . . . 1) and stores them in the sgpmMPMList in ascending order. numStored is 16. It is noted that the number of modes currently selected may be changed, for example, it may be increased from 16 to 17, 18, and so on, or decreased from 16 to 14, 12, 10, and so on.

### Partition Mode and Intra Prediction Mode Selection Unit 4715

The partition mode and intra prediction mode selection unit 4715 selects the candidate in sgpmMPMList for the current block indicated by sgpm_index. sgpm_index is decided and encoded by video coding apparatus 11. When comparing the cost, the SGPM method uses a complete traversal method to compare each candidate. spgm_index is derived by the coding parameter determination unit 110 and the prediction parameter derivation unit 120. The coding parameter determination unit 110 and the prediction parameter derivation unit 120 creates prediction images of the same size as the current block for every candidates, it means numStored intra prediction modes in sgpmMPMList.

### Second Embodiment

### Intra Prediction Mode Candidate Derivation Unit

The intra prediction mode candidate derivation unit 4712 derives a list of intra prediction modes, named IPModeList for the current block. The length of IPModeList is numIPMode, which may set equal to 1, 2, 3, 4, 5 or other values. Some elements of IPModeList can be set equal to fixed modes, e.g. PLANAR_IDX (planar mode), VER_IDX (vertical direction for angular mode), and HOR_IDX (horizontal direction for angular mode). Other elements can be determined based on the neighbouring pixel's information of the current block. For example, element can include DIMD method (dimdBestMode, dimdHorMode, and dimdVerMode) derived by DIMD prediction unit 31048. This allows all 67 intra prediction modes to be filled into the list. 67 intra prediction modes are from 0 to 66 shown in FIG. 3. dimdBestMode is mode with the minimum DIMD cost. As explained above, dimdHorMode and dimdVerMode are modes with the minimum cost from the left template and the upper template calculated in DIMD method, respectively. Including dimdHorMode and dimdVerMode to intra prediction candidate list for SGPM has the benefit of coding efficiency. Furthermore, the element of the list can set equal to the intra prediction mode of the adjacent blocks which may include blocks located to the above-left, bottom-left, left, top, and above-right of the current block.

As a summary, an video decoding apparatus comprises 1) DIMD candidate derivation unit derives gradients using top left and left and top regions of the target block and derive intra prediction modes of dimdHorMode, dimdVerMode where dimdHorMode and dimdVerMode is derived based on the left region and top region respectively, 2) prediction mode candidate derivation unit, configured to derive the second candidate list using the dimdHorMode and the dimdVerMode.

It is worth mentioning that the elements in IPModeList cannot include any modes obtained through the TIMD method in this embodiment. This avoids dependency between the SGPM method and the TIMD method.

The operation of template prediction image generation unit 4713, template cost derivation unit 4714 and partition mode and Intra prediction mode selection unit 4715 are the are the same as that of First Embodiment already described, and thus descriptions thereof will be omitted.

### SGM Controlled Based on High Level Syntax

### Embodiment 1: SGM Controlled Based on sps_sgpm_enabled_flag and sps_dimd_enabled_flag

In one embodiment, DIMD prediction unit 31048 and SGPM prediction unit 31047 may have control flags as follow.

Parameter decoding unit 302 decodes high level flag, such as sps_dimd_enabled_flag and sps_sgpm_enabled_flag from the bitstream. Those flags may be decoded from SPS or picture header or slice header. sps_dimd_enabled_flag equal to 1 specifies that DIMD may be used. sps_dimd_enabled_flag equal to 0 specifies that DIMD is not used. sps_sgpm_enabled_flag equal to 1 specifies that DIMD may be used. sps_sgpm_enabled_flag equal to 0 specifies that SGPM is not used. If sps_dimd_enabled_flag is equal to 1, DIMD prediction unit 31048 performs DIMD method to generate DIMD prediction image. If sps_sgm_enabled_flag is equal to 1, SGPM prediction unit 31047 performs SGPM method to generate SGPM prediction image. If sps_sgpm_enabled_flag is equal to 1 and sps_dimd_enabled_flag is equal to 1, SGPM prediction unit 31047 performs SGPM method in which one or more DIMD intra prediction modes are used for the SGPM candidate. i.e. dimdBestMode, dimdVerMode and dimdHorMode are included in IPModeList. If sps_sgpm_enabled_flag is equal to 1 and sps_dimd_enabled_flag is equal to 0, SGPM prediction unit 31047 performs SGPM method in which any of DIMD intra prediction modes is not used for the SGPM candidate. i.e. dimdBestMode, dimdVerMode and dimdHorMode is not included in IPModeList. Decoding high level flags and enable DIMD prediction mode in SGPM has the benefit of balancing coding efficiency and complexity in encoder side.

### Embodiment 2: SGM Controlled Based on Three Flags

In one embodiment, DIMD prediction unit 3108, TIMD prediction unit 31046 and SGPM prediction unit 31047 may have control flags as follow.

In addition to Embodiment 1, parameter decoding unit 302 decodes sps_timd_enabled_flag from the bitstream. The flag may be decoded from SPS or picture header or slice header. sps_timd_enabled_flag equal to 1 specifies that TIMD may be used. sps_timd_enabled_flag equal to 0 specifies that TIMD is not used. If sps_sgpm_enabled_flag is equal to 1 and sps_dimd_enabled_flag is equal to 1, SGPM prediction unit 31047 performs SGPM method in which one or more DIMD intra prediction modes are used for the SGPM candidate. i.e. dimdBestMode, dimdVerMode and dimdHorMode are included in IPModeList. If sps_sgpm_enabled_flag is equal to 1 and sps_timd_enabled_flag is equal to 1, SGPM prediction unit 31047 performs SGPM method in which one or moreTIMD intra prediction modes are used for the SGPM candidate but none of DIMD intra prediction modes is used for the SGPM candidate. i.e. timdMode is not included in IPModeList. If sps_sgpm_enabled_flag is equal to 1 and sps_dimd_enabled_flag is 1 and sps_timd_enabled_flag is equal to 1, SGPM prediction unit 31047 performs one or more DIMD intra prediction modes are used for the SGPM candidate but no TIMD intra prediction modes are used, i.e. dimdBestMode, dimdVerMode and dimdHorMode are included in IPModeList but TIMD intra prediction modes are not included. This architecture has the benefit of complexity reduction in decoder side in which even if both DIMD and TIMD are enabled, only DIMD or TIMD based (here DIMD) candidate is included in SGPM candidate. It can avoid thee operation is simultaneously used. If sps_timd_enabled_flag is equal to 0, TIMD based Intra prediction is not used for SGPM candidate and If sps_dimd_enabled_flag is equal to 0, DIMD based Intra prediction is not used for SGPM candidate.

### Embodiment 3: SGM Controlled Based on Three Flags

In other embodiment, sps_sgpm_enabled_flag is equal to 1 and sps_dimd_enabled_flag is 1 and sps_timd_enabled_flag is equal to 1, SGPM prediction unit 31047 performs one or more TIMD intra prediction modes as the SGPM candidate but none of DIMD intra prediction modes as the SGPM candidate. i.e. TIMD intraprediction modes are included in IPModeList. This architecture has the benefit of complexity reduction in decoder side in which even if both DIMD and TIMD are enabled, only DIMD or TIMD based (here TIMD) candidate is included in SGPM candidate.

### TIMD Prediction Unit 31046

The TIMD method is indicated by the timd_flag, where a value of 1 indicates that the current block is predicted using the TIMD method. In this case, TIMD derives the timdMode, timdSecondaryMode, and a fusion flag (i.e. fusionFlag) from the reconstructed neighboring regions of the current block and generate the pixel values for the current block.

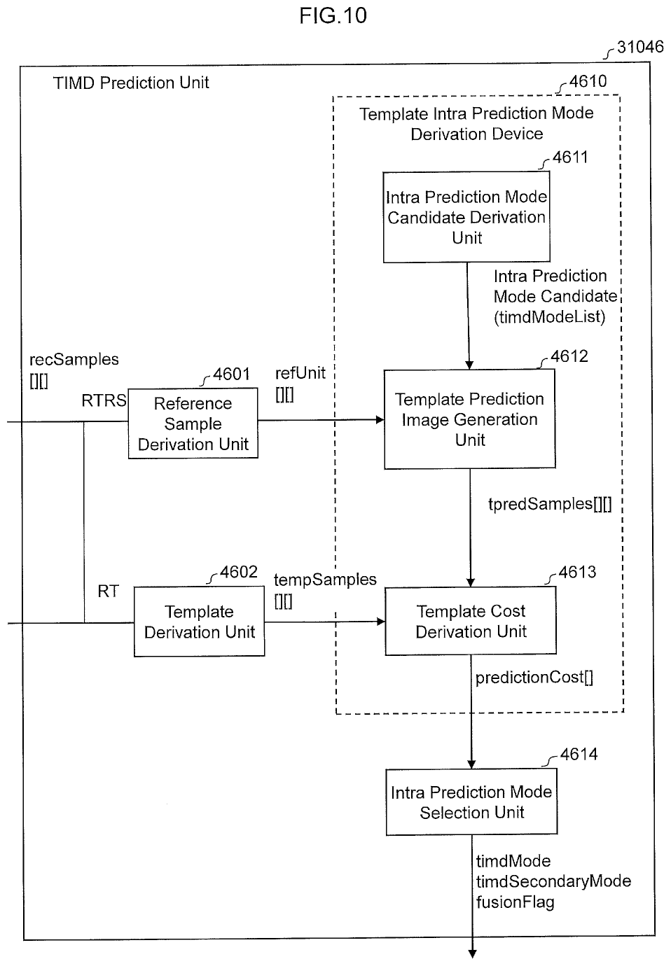

FIG. 10 illustrates the structure of the TIMD prediction unit 31046 in this embodiment. It consists of a reference sample derivation unit 4601, a template derivation unit 4602, an intra prediction mode candidate derivation unit 4611, a template prediction image generation unit 4612, a template cost derivation unit 4613, and an intra prediction mode selection unit 4614. The intra prediction mode candidate derivation unit 4611, template prediction image generation unit 4612, and template cost derivation unit 4613 can be collectively referred to as the template intra prediction mode derivation device 4610.

FIG. 7 illustrates the template region RT and the template reference region (template reference sample region) RTRS used for TIMD prediction. The template region corresponds to the region of the template image, while the template reference region RTRS is the reference region used to generate the template prediction image.

The TIMD prediction unit 31046 utilizes the image from the template reference region RTRS, located near the target block, to generate template prediction images for intra prediction mode candidates and select the best intra prediction mode suitable for the target block.

The TIMD prediction unit 31046 utilizes the template image tempSamples, generated from the image of the template region RT, and accurate intra prediction modes to derive the template prediction image tpredSamples. Specifically, the TIMD prediction unit 31046 performs the following steps:
Step 1-1: Derive the template reference region RTRS and the intra prediction mode list timdModeList. The timdModeList can be determined by the MPMList (both have the same content). The length of the MPMList is 22 and may include angular prediction modes, planar mode, DC mode, prediction modes derived from the decoder-side intra mode derivation (DIMD), and so on.
Step 1-2: Iterate through the predModeList to check if it includes DC mode, Hor mode, and Ver mode. Append the modes that are not included in the predModeList, resulting in four possible lengths for the predModeList: 22, 23, 24, 25. Then derive the timdModeList from the predModeList.
Step 1-3: Derive the prediction images tpredSamples for all modes in the timdModeList.
Step 1-4: Derive the cost values representing the differences between each tpredSamples and tempSamples.
Step 2-1: Select the tpredSamples corresponding to the intra prediction mode with the lowest cost value, indicating the highest prediction accuracy, as the timdBestMode.
Step 2-2: Select the tpredSamples corresponding to the intra prediction mode with the second-lowest cost value, indicating the second-highest prediction accuracy, as the timdSecondaryMode.
Step 3: Determine whether to perform fusion based on the relative costs of the timdBestMode and timdSecondaryMode.
Step 4: Generate the intra prediction image predSamples using the selected results from Step 3 and the intra prediction mode selected in Step 2.

The following provides a more detailed explanation of the processes in each component of the TIMD prediction unit 31046 as shown in FIG. 10.

### Intra Prediction Mode Candidate Derivation Unit 4611

The intra prediction mode candidate derivation unit 4611 derives a list of intra prediction mode candidates, timdModeList[ ], from the intra prediction modes of adjacent blocks. For example, the MPMList can be used as timdModeList.

$$timdModeList [ i ] = MPMList [ i ] ( i = 0 … numMPM - 1 )$$

Here, numMPM represents the number of elements in the candModeList, which may be set to 22. numTimdCand is MPMCand.

Alternatively intra prediction mode candidate derivation unit 4611 may derive timdModeList, such as adding only part (the first numTimdCand) of MPMList to timdModeList.

$$timdModeList [ i ] = MPMList [ i ] ( i = 0 … numTimdCand - 1 )$$

Where numTimdCand is set less than number of MPMCand and the value may be between 2 and MPMCand−1. By setting the TIMD list is shorter than MPM list, the decoder complexity reduction is achieved without introducing major loss.

In one example, numTimdCand is equal to numMPM divided by 2 (num TimdCand=numMPM>>1).

Alternatively, numTimeCand is equal to quarter of numMPM (numTimdCand=numMPM>>2).

Additionally, Intra prediction mode candidate derivation unit 4611 may use rounding to determine the value of numTimdCand. e.g. numTimdCand=(numMPM+roundoffset)>>2. roundoffset may be 3 or 1 to 4 values.

In addition, using a pre-defined list (default candidate list), addList={DC_IDX, HOR_IDX, VER_IDX}, the intra prediction mode candidate derivation unit 4611 may add the elements, from addList, that do not exist in timdModeList. Now numTimdCand may be increased (updated) from numTimdCand to numTimdCand, numTimdCand+1, numTimdCand+2, num TimdCand+3.

Alternatively the elements in the addList are appended to the end of MPMList before constructing timdModeList. In this case, intra prediction mode candidate derivation unit 4611 may add part of MPMList to timdCandList. Specifically,

$$timdModeList [ i ] = MPMList [ i ] ( i = 0 … numTimdCand - 1 )$$

$$timdModeList [ j + numTimdCand ] = MPMList [ numMPMCand - 1 + j ] ( j = 0 … numAddedList - 1 )$$

where numMPMCand is the length of MPMList before adding addList and numAddedList is equal to the number of candidate which is added from addList. This makes the default candidates prioritized so that the decoder complexity reduction is achieved by reducing the length of timdCandList.

An video decoding apparatus comprising 1) an MPM candidate derivation unit configured to derive a MPM candidate list of intra prediction modes with numMPM candidates, 2) a prediction mode candidate derivation unit configured to derive a timd candidate with numTimdCand candidates using MPM candidate list where numTimdCand is less than numMPM, 3) a template prediction image generation unit configured to generate template prediction images based on the intra prediction modes in the timd candidate list, 4) a template cost derivation unit configured to derive the costs between the template prediction images and a template image, 5) a candidate selection unit configured to select an intra prediction mode with the minimum cost, 6) a image prediction unit to derive an prediction image using the selected intra prediction mode.

In addition, intra prediction mode candidate derivation unit 4611 may reorder timdModeList based on elements's selection frequency based on their cost. Alternatively intra prediction mode candidate derivation unit 4611 may reorder MPMList before constructing timdModeList. Specifically MPMList are sorted in descending order of selection frequency in which the highest occurrence mode is stored in the first position of the list.

Template derivation unit 4602 outputs the template image tempSamples of the target block. As shown in FIG. 7, it can be generated from the adjacent template region RT, where RT is composed of L-shaped decoded pixels recSamples with a width of 1 pixel.

tempSamples [i] [j]=recSamples [x0+i] [y0+j], where i=0 . . . curBlockWidth−1, j=−1 and i=−1, j=0 . . . curBlockHeight−1.

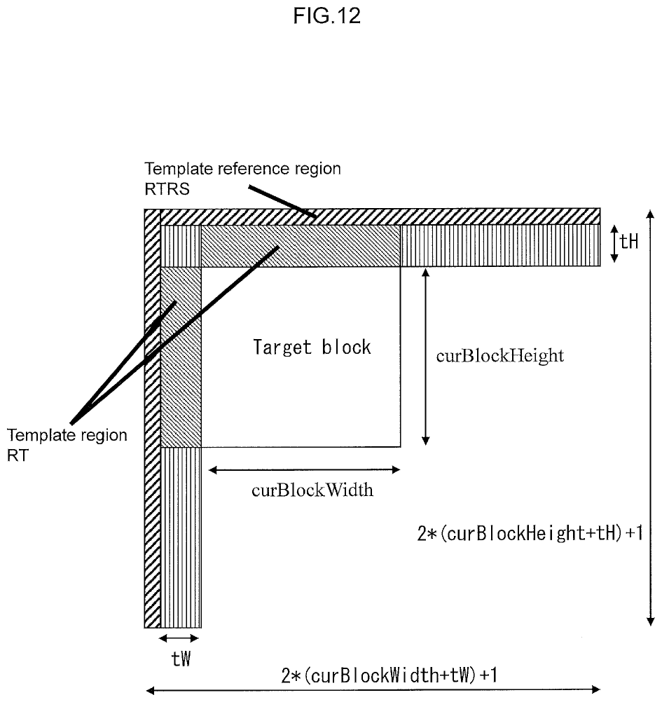

The region on recSamples referred to as the template region RT is represented by the coordinates (i, j). tW and tH respectively represent the width and height of the template image. Thus, RT={{i=0 . . . curBlockWidth−1, j=−1}, {i=−1, j=0 . . . curBlockHeight−1}}. In FIG. 7, (tW, tH)=(1, 1). Alternatively, the decoded image array recSamples corresponding to the template region can be used as the template image. FIG. 12 shows the relationship between the target block, template region RT, and template reference region.

Reference sample derivation unit 4601 derives the reference sample refUnit from the template reference region RTRS. The operation of reference sample derivation unit 4601 can also be performed by the reference sample filtering unit 3103.

$$refUnit [ x ] [ y ] = recSamples [ x 0 + x ] [ y 0 + y ]$$

Here, x takes the range of −tW−1 to refW−1, and y takes the range of −tH−1 to refH−1. tW and tH represent the width and height of the template region, and in FIG. 7, tW=1 and tH=1. refW=curBlockWidth, refH=curBlockHeight, but not limited to these values. refW can be curBlockWidth*2, refH can be curBlockHeight*2, or refW can be curBlockWidth*4, refH can be curBlockHeight*4.

Reference sample derivation unit 4601 may derive the reference sample p[x][y] by applying filtering to the reference sample refUnit[x][y]. Template prediction image generation unit 4612 generates the predicted image (template prediction image tpredSamples) of the intra prediction mode in timdModeList from the template reference region RTRS. The operation of predicting the image in template prediction image generation unit 4612 may also be performed by the prediction unit 3104. For example, the planar prediction unit 31041, DC prediction unit 31042, and angular prediction unit 31043 may derive the template prediction image and target block prediction image.

In the template cost derivation unit 4613, the Sum of Absolute Transformed Differences (SATD) cost is calculated by comparing the tempSamples with tpredSamples.

By calculating the SATD cost for all modes in timdModeList and comparing them, the mode with the minimum cost (timdMode) and the mode with the second minimum cost (timdSecondaryMode) are selected. And determine whether to perform fusion operation based on timdMode and timdSecondaryMode.

```
  if (timdSecondaryCost < timdBestCost ∥ (timdSecondaryCost −
timdBestCost < timdBestCost))
  {
  fusionFlag = true;
  }
  else
  {
  fusionFlag = false;
  }
```

If fusionFlag is true, the prediction image is generated with weighted average of prediction image with timdBestMode, otherwise (fusionFlag is false) the prediction image is generated with weighted average of prediction image with timdSecondaryModel.

The inverse quantization and inverse transform processing unit 311 performs inverse quantization on a quantization transform coefficient input from the prediction parameter derivation unit 320 to calculate a transform coefficient. This quantization transform coefficient is a coefficient obtained by performing a frequency transform such as a Discrete Cosine Transform (DCT), a Discrete Sine Transform (DST), or the like on prediction errors to quantize in coding processing. The inverse quantization and inverse transform processing unit 311 performs an inverse frequency transform such as an inverse DCT, an inverse DST, or the like on the calculated transform coefficient to calculate a prediction error. The inverse quantization and inverse transform processing unit 311 outputs the prediction error to the addition unit 312.

The addition unit 312 adds the prediction image of the block input from the intra prediction image generation unit 310 and the prediction error input from the inverse quantization and inverse transform processing unit 311 for each pixel and generates a decoded image of the block. The addition unit 312 stores the decoded image of the block in the reference picture memory 306 and outputs the image to the loop filter 305.

### Configuration of Video Coding Apparatus

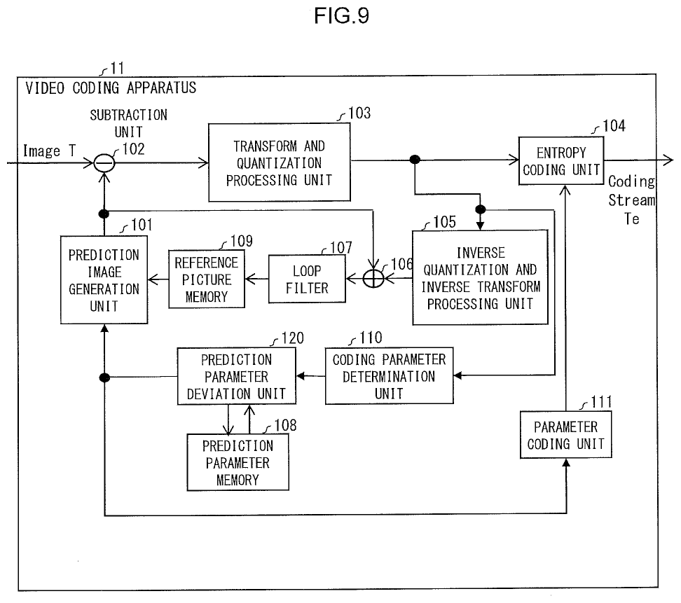

Next, a configuration of the video coding apparatus 11 according to the present embodiment is described. FIG. 9 is a block diagram illustrating a configuration of the video coding apparatus 11 according to the present embodiment. The video coding apparatus 11 is configured to include a prediction image generation unit 101, a subtraction unit 102, a transform and quantization processing unit 103, an inverse quantization and inverse transform processing unit 105, an addition unit 106, a loop filter 107, a prediction parameter memory (a prediction parameter storage unit, a frame memory) 108, a reference picture memory (a reference image storage unit, a frame memory) 109, a coding parameter determination unit 110, a parameter coding unit 111, prediction parameter derivation unit 120, and an entropy coding unit 104.

The prediction image generation unit 101 generates a prediction image for each CU that is a region obtained by splitting each picture of the image T. The operation of the prediction image generation unit 101 is the same as that of the intra prediction image generation unit 310 already described, and thus descriptions thereof is omitted.

The subtraction unit 102 subtracts a pixel value of the prediction image of the block input from the prediction image generation unit 101 from a pixel value of the image T to generate a prediction error. The subtraction unit 102 outputs the prediction error to the transform and quantization processing unit 103.

The transform and quantization processing unit 103 calculates a transform coefficient by performing a frequency transform on the prediction error input from the subtraction unit 102, and derives a quantization transform coefficient by quantization. The transform and quantization processing unit 103 outputs the quantization transform coefficient to the entropy coding unit 104 and the inverse quantization and inverse transform processing unit 105.

The inverse quantization and inverse transform processing unit 105 is the same as the inverse quantization and inverse transform processing unit 311 (FIG. 4) in the video decoding apparatus 31, and descriptions thereof are omitted. The calculated prediction error is output to the addition unit 106.

To the entropy coding unit 104, the quantization transform coefficient is input from the transform and quantization processing unit 103, and coding parameters are input from the parameter coding unit 111. The entropy coding unit 104 performs entropy coding on split information, the prediction parameters, the quantization transform coefficient, and the like to generate and output the coding stream Te.

The parameter coding unit 111 instructs the entropy coding unit 104 to encode the prediction parameters and quantization coefficients, derived from the prediction parameter derivation unit 120.

The prediction parameter derivation unit 120 derives the syntax element from the parameters inputted from the coding parameter determination unit 110. Some parts of the prediction parameter derivation unit 120 have the same structure as the prediction parameter derivation unit 320.

The addition unit 106 adds a pixel value of the prediction image of the block input from the prediction image generation unit 101 and the prediction error input from the inverse quantization and inverse transform processing unit 105 to each other for each pixel, and generates a decoded image. The addition unit 106 stores the generated decoded image in the reference picture memory 109.

The loop filter 107 applies a deblocking filter, an SAO, and an ALF to the decoded image generated by the addition unit 106. Note that the loop filter 107 need not necessarily include the above-described three types of filters, and may have a configuration of only the deblocking filter, for example.

The prediction parameter memory 108 stores the prediction parameters generated by the prediction parameter derivation unit 120 for each target picture and CU at a predetermined position. It may stores the transform coefficients created by the transform and quantization processing unit 103.

The reference picture memory 109 stores the decoded image generated by the loop filter 107 for each target picture and CU at a predetermined position.

The coding parameter determination unit 110 selects one set among multiple sets of coding parameters. A coding parameter refers to the above-mentioned QT, BT, or TT split information, the prediction parameter, or a parameter to be coded, the parameter being generated in association therewith. The prediction image generation unit 101 generates the prediction image by using these coding parameters.

The coding parameter determination unit 110 calculates, for each of the multiple sets, an RD cost value indicating the magnitude of an amount of information and a coding error. The RD cost value is, for example, the sum of a code amount and the value obtained by multiplying a coefficient λ by a square error. The coding parameter determination unit 110 selects a set of coding parameters of which cost value calculated is a minimum value. With this configuration, the entropy coding unit 104 outputs the selected set of coding parameters as the coding stream Te. The coding parameter determination unit 110 outputs the determined coding parameters in the parameter coding unit 111, the prediction parameter derivation unit 120, the prediction image generation unit 101.

Note that, some of the video coding apparatus 11 and the video decoding apparatus 31 in the above-described embodiment, for example, the entropy decoding unit 301, the parameter decoding unit 302, the loop filter 305, the intra prediction image generation unit 310, the inverse quantization and inverse transform processing unit 311, the addition unit 312, the prediction parameter derivation unit 320, the prediction image generation unit 101, the subtraction unit 102, the transform and quantization processing unit 103, the entropy coding unit 104, the inverse quantization and inverse transform processing unit 105, the loop filter 107, the coding parameter determination unit 110, and the parameter coding unit 111, the prediction parameter derivation unit 120, may be realized by a computer. In that case, this configuration may be realized by recording a program for realizing such control functions on a computer-readable recording medium and causing a computer system to read the program recorded on the recording medium for execution. Note that the “computer system” mentioned here refers to a computer system built into either the video coding apparatus 11 or the video decoding apparatus 31 and is assumed to include an OS and hardware components such as a peripheral apparatus. Furthermore, a “computer-readable recording medium” refers to a portable medium such as a flexible disk, a magneto-optical disk, a ROM, a CD-ROM, and the like, and a storage device such as a hard disk built into the computer system. Moreover, the “computer-readable recording medium” may include a medium that dynamically stores a program for a short period of time, such as a communication line in a case that the program is transmitted over a network such as the Internet or over a communication line such as a telephone line, and may also include a medium that stores the program for a fixed period of time, such as a volatile memory included in the computer system functioning as a server or a client in such a case. Furthermore, the above-described program may be one for realizing some of the above-described functions, and also may be one capable of realizing the above-described functions in combination with a program already recorded in a computer system.

Furthermore, a part or all of the video coding apparatus 11 and the video decoding apparatus 31 in the embodiment described above may be realized as an integrated circuit such as a Large Scale Integration (LSI). Each function block of the video coding apparatus 11 and the video decoding apparatus 31 may be individually realized as processors, or part or all may be integrated into processors. The circuit integration technique is not limited to LSI, and the integrated circuits for the functional blocks may be realized as dedicated circuits or a multi-purpose processor. In a case that with advances in semiconductor technology, a circuit integration technology with which an LSI is replaced appears, an integrated circuit based on the technology may be used. The embodiment of the present disclosure has been described in detail above referring to the drawings, but the specific configuration is not limited to the above embodiments and various amendments may be made to a design that fall within the scope that does not depart from the gist of the present disclosure.

The embodiment of the present invention may be applied to a video decoding device that decodes encoded data of image data, and a video encoding device that generates encoded data from image data. In addition, the data structure of the encoded data is generated by the video encoding device and referenced by the video decoding device.

### REFERENCE SIGNS LIST

31 Image decoding apparatus
301 Entropy decoding unit
302 Parameter decoding unit
310 Prediction image generation unit
3104 Intra prediction unit
31046 TIMD prediction unit
31047 SGPM prediction unit
31048 DIMD prediction unit
4601 Reference sample derivation unit
4602 Template derivation unit
4610 Template intra prediction mode derivation device
4611 Intra prediction mode candidate derivation unit
4612 Template prediction image generation unit
4613 Template cost derivation unit
4614 Intra prediction mode selection unit
4701 Reference sample derivation unit
4702 Template derivation unit
4710 Prediction mode derivation device
4711 Partition mode candidate derivation unit
4712 Intra prediction mode candidate derivation unit
4713 Template prediction image generation unit
4714 Template cost derivation unit
4715 Partition mode and intra prediction mode selection unit
311 Inverse quantization and inverse transform processing unit
312 Addition unit
11 Image coding apparatus
101 Prediction image generation unit
102 Subtraction unit
103 Transform and quantization processing unit
104 Entropy coding unit
105 Inverse quantization and inverse transform processing unit
107 Loop filter
110 Coding parameter determination unit
111 Parameter coding unit

1. A video decoding apparatus for generating a TIMD prediction image, the video decoding apparatus comprising:
an MPM candidate derivation unit circuit configured to derive an MPM candidate list of intra prediction modes with numMPM candidates,
an intra prediction mode candidate derivation circuit configured to derive a timd candidate with numTimdCand candidates using an MPM candidate list where numTimdCand is less than numMPM,
a template prediction image generation circuit configured to generate template prediction images based on the intra prediction modes in a timd candidate list,
a template cost derivation circuit configured to derive costs between the template prediction images and a template image,
an intra prediction mode selection circuit configured to select an intra prediction mode with a minimum cost, and
an image prediction circuit configured to derive a prediction image using the intra prediction mode.

2. A video decoding apparatus for generating a SGPM prediction image, the video decoding apparatus comprising:
a parameter decoding circuit configured to decode an sgpm index from a bitstream,
a partition mode candidate derivation circuit configured to derive a first candidate list of partition modes as partModeList,
an intra prediction mode candidate derivation circuit configured to derive a second candidate list of intra prediction modes based on a neighboring block as IPModeList,
a template prediction image generation circuit configured to derive template prediction images based on the intra prediction modes in the first candidate list and the partition modes in the first candidate list,
a template cost derivation circuit configured to calculate costs between the template prediction images and a template image and generate a third candidate list,
a partition mode and intra prediction mode selection circuit configured to select an intra prediction mode and a partition mode for a current block from the third candidate list indicated by the sgpm index, and
an image prediction circuit configured to derive a prediction image using the intra prediction mode and the partition mode.

3. The video decoding apparatus of claim 2
further comprising a DIMD prediction circuit configured to (1) derive gradients using a top left region, a left region, and a top regions of a target block, and (2) derive intra prediction modes of a dimdHorMode, and a dimdVerMode, where the dimdHorMode and the dimdVerMode are determined based on the left region and the top region respectively,
wherein the intra prediction mode candidate derivation circuit configured to derive the second candidate list using the dimdHorMode and the dimdVerMode.

4. The video decoding apparatus of claim 2
further comprising a TIMD prediction circuit configured to generate a template prediction image,
wherein the intra prediction mode selection circuit configured to derive the second candidate list using a timd intra prediction mode.

5. (canceled)

6. A video decoding apparatus comprising:
a partition mode candidate derivation circuit configured to derive partition modes of a target block using pixels of a neighboring image and a first candidate list,
a prediction mode candidate derivation circuit configured to derive a second candidate list of intra prediction modes based on information of the target block's and a neighbouring block,
a template prediction image generation circuit configured to generate template prediction images based on the intra prediction modes in the second candidate list and the partition modes in the first candidate list,
a template cost derivation circuit configured to derive costs between the template prediction images and a template image and generate a third candidate list,
a partition mode and intra prediction mode selection circuit configured to selects an intra prediction mode and a partition mode for a current block from the third candidate list indicated by an index and
an intra prediction circuit configured to derive a prediction image using the intra prediction mode and the partition mode.

7. The video decoding apparatus according to claim 6, wherein the prediction mode candidate derivation circuit expands a size of the second candidate list.

8. The video decoding apparatus according to claim 6, wherein the prediction mode candidate derivation circuit expands a size of the second candidate list using a size of the target block and thresholds.

9. The video decoding apparatus according to claim 6, wherein the prediction mode candidate derivation circuit expands a size of the second candidate list using a shape of the target block.

10. The video decoding apparatus according to claim 6, wherein the prediction mode candidate derivation circuit derives the second candidate list using refinement intra prediction modes and wide angle prediction modes.

11. (canceled)
